(19) United States
(12) Patent Application Publication
(10) Pub. No.: US 2008/0050117 A1
(43) Pub. Date: Feb. 28, 2008

(54) Method and apparatus for photonic resiliency of a packet switched network

(76) Inventor: Bikash Koley, Greenbelt, MD (US)

Correspondence Address: MORGAN LEWIS & BOCKIUS LLP, 1111 PENNSYLVANIA AVENUE NW, WASHINGTON, DC, 20004, US

(21) Appl. No.: 11/808,781

(22) Filed: Jun. 12, 2007

Related U.S. Application Data
(60) Provisional application No. 60/812,492, filed on Jun. 12, 2006.
(60) Provisional application No. 60/812,496, filed on Jun. 12, 2006.

(51) Int. Cl. H04J 14/00

(52) U.S. Cl. 398/49

(57) ABSTRACT

A resilient photonic network includes a plurality of resilient switching nodes, each node comprising a photonic switch and one of a Layer-2/3 switch and router, and a plurality of bi-directional ports, each connected between the photonic switch the one of a Layer-2/3 switch and router, wherein at least one optical signal having a specific wavelength is transmitted through a first network port of a first one of the plurality of resilient switching nodes to an adjacent second one of the plurality of resilient switching nodes and the at least one optical signal is transmitted through a second network port of the first one of the plurality of resilient switching nodes to an adjacent third one of the plurality of resilient switching nodes to establish a bi-directional connectivity between the first, second, and third pluralities of resilient switching nodes.

This application claims priority to U.S. Provisional Application 60/812,492 filed Jun. 12, 2006 and U.S. Provisional Application 60/812,496 filed Jun. 12, 2006. This application incorporates by reference these two provisionals.

### BACKGROUND OF THE INVENTION

1. Field of the Invention

The present invention relates generally to communication networks and more specifically to a method and an apparatus for establishing a resilient photonic packet switched network.

2. Background of the Invention

As metro and access area networks constantly evolve to support new packet-based services such as voice-over-internet-protocol and IP-television, traditional circuit-switched networks are not suitable to cost-effectively deliver these services any more. Traditional Metropolitan Area Networks (MAN) have predominantly been based on the Synchronous Optical NETwork (SONET) technology. SONET based circuit switched networks offer some very desirable network features such as automatic protection switching ability. In the event of a link failure, SONET equipment can detect the failure and switch to redundant path or link in less than 50 milliseconds. However, SONET is a multiplexing technology with rigid time-division multiplexing hierarchy. This leads to a very inefficient use of bandwidth while carrying asynchronous packet based traffic. Also, due to the signaling time limitations, SONET cannot guarantee faster than 50-ms restoration time. A much better solution would be a packet-based layer-2 or layer-3 network built on Ethernet or Internet Protocol (IP), respectively, consisting of Ethernet switches or IP routers. One common means of providing resiliency in such networks is by having redundant connections either in a ring topology or in a mesh topology. However, Ethernet switches will not work properly if there is a ring or loop in the topology. In order to provide self restoration while still preventing loops, techniques such as IEEE 802.1d Spanning Tree Protocol (STP) or IEEE 802.1w Rapid Spanning Tree were invented to detect and remove loops. These techniques are slow and cannot provide automatic protection switching in a deterministic manner in less than 50 ms. Ethernet standard and Ethernet's prior-art protection mechanisms are described in IEEE standard: IEEE Std. 802.3 “Carrier sense multiple access with collision detection (CSMA/CD) access method and physical layer specifications”.

To achieve deterministic sub-50 ms network restoration in a packet network, the IEEE created 802.17 Resilient Packet Ring (RPR) standard. The IETF on the other hand are looking at Multiprotocol Label Switching (MPLS) with Fast Reroute capabilities. Both of these approaches are quite complex. RPR requires a new Media Access Control (MAC) Layer, and MPLS requires extensive signaling. Because of the complexities, these approaches will drive up the cost of the nodes on the ring.

There have also been some efforts to modify the standard Ethernet protocols or framings to support faster network restoration. One such method is described in U.S. Pat. No. 6,621,818 entitled “RING CONFIGURATION FOR NETWORK SWITCHES”. This invention provides a method of connecting multiple gigabit packet switching devices in ring configuration. In this method, each switch uses a proprietary ring-ID number to prevent broadcast storm and also to utilize built-in redundancy feature of the ring. There is another prior-art method described in U.S. Pat. No. 7,003,705 entitled “ETHERNET AUTOMATIC PROTECTION SWITCHING” that relies upon proprietary manipulation of Ethernet frames and VLAN tags to achieve automatic protection switching in Ethernet networks. In U.S. Pat. No. 6,928,050 entitled “PROTECTED SWITCHING RING” a proprietary signaling mechanism is described between the switching nodes to achieve 50 ms protection switching in Ethernet networks. Since these prior-art methods rely upon non-standard Ethernet framing or signaling, the method is not applicable in a heterogeneous network with Ethernet/IP equipments from multiple suppliers. Also, none of these prior art methods can achieve automatic network restoration in significantly less than 50 ms, which is a requirement to preserve quality of experience for packet based video services.

The present invention introduces a new way (Photonic Resiliency and Integrated Switching Mechanism or “PRISM”) of providing deterministic fast protection switching in a packet ring network built with off-the-shelf switches and/or routers without requiring any modification of the MAC layer or non-standard signaling between ring nodes.

### SUMMARY OF THE INVENTION

(BK. This deleted paragraph seems to be cut and paste from an unrelated document)

An object of the present invention is to provide deterministic fast protection switching in a packet ring network.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a resilient photonic network includes a plurality of resilient switching nodes, each node comprising a photonic switch and one of a Layer-2/3 switch and router, and a plurality of bi-directional ports, each connected between the photonic switch the one of a Layer-2/3 switch and router, wherein at least one optical signal having a specific wavelength is transmitted through a first network port of a first one of the plurality of resilient switching nodes to an adjacent second one of the plurality of resilient switching nodes and the at least one optical signal is transmitted through a second network port of the first one of the plurality of resilient switching nodes to an adjacent third one of the plurality of resilient switching nodes to establish a bi-directional connectivity between the first, second, and third pluralities of resilient switching nodes.

In another aspect, a photonic resiliency and integrated switching mechanism device includes a plurality of line cards, each line card having at least one bi-directional optical fiber port to transmit and receive a primary wavelength and a reserve wavelength, wherein an egress of the bi-directional optical fiber port of a first one of the plurality of line cards is connected to an ingress of the bi-directional optical fiber port of a second one of the plurality of line cards, and wherein an egress of the bi-directional optical fiber port of the second one of the plurality of line cards is connected to an ingress of the bi-directional optical fiber port of the first one of the plurality of line cards.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 shows a schematic of an example Photonic Resiliency and Integrated Switching Mechanism (PRISM) based packet switched network;

FIG. 2 shows the underlying layer-2 and layer-3 topology established with the PRISM system illustrated in FIG. 1 under NORMAL operating condition;

FIG. 3 shows a link failure event in the example PRISM network illustrated in FIG. 2;

FIG. 4 shows an automatic protection switching event upon detection of link failure in a PRISM network illustrated in FIG. 3;

FIG. 5 shows the restored layer-2, layer-3 topology after the protection switching event illustrated in FIG. 4;

FIG. 6 shows the block diagram view of a preferred embodiment of a PRISM network node in normal operating condition;

FIG. 7 shows the block diagram view of the preferred embodiment of a PRISM network node illustrated in FIG. 7 during an example link failure and protection switching event;

FIG. 8 shows the detailed block diagram view of a PRISM line card shown in the preferred embodiment illustrated in FIG. 6;

FIG. 9 shows the block diagram view of a second preferred embodiment of a PRISM network node in normal operating condition;

FIG. 10 shows the block diagram view of the second preferred embodiment of a PRISM network node illustrated in FIG. 9 during an example link failure and protection switching event;

FIG. 11 shows the block diagram view of a third preferred embodiment of a PRISM network node in normal operating condition; and

FIG. 12 shows the block diagram view of the third preferred embodiment of a PRISM network node illustrated in FIG. 11 during an example link failure and protection switching event.

### DETAILED DESCRIPTION OF THE PREFERRED INVENTION

The present invention will now be disclosed more fully with reference to the accompanying drawings, in order to disclose selected embodiments. This invention may, however, be embodied in many different forms and should not be construed as limited to the embodiment set forth herein. It will also be understood by those skilled in the art that the present invention may be practiced with only some or all aspects of the present invention. For the purpose of a thorough understanding and explanation, the selected embodiments are disclosed herein with the help of specific numbers, materials and configurations. However, it will also be apparent to those skilled in the art that the present invention may be practiced without these specific details.

As is understood by those skilled in the art, communication networks are often described in reference to a network layer model such as one specified by the International Standards Organization (ISO) in the Open System Interface (OSI) reference model. In particular, these layers include the application layer, the presentation layer, the session layer, the transport layer, the network layer, the data link layer and the physical layer. Part of the description of a communication network in this invention disclosure will reference this network layer reference model. For example, layer-1, layer-2 and layer-3 in this document refer to the physical layer, the data link layer and the network layer respectively, as is understood by those skilled in the art.

Additionally, various operations will be described as multiple discrete steps in turn in a manner that is helpful in understanding some embodiments of this invention. However, the order of description should not be construed as to imply that these operations are necessarily order dependent, in particular, the order of their presentation.

Parts of this invention disclosure will be presented using terms such as network ports, data, link, fault, packet, and the like, consistent with the manner commonly employed by those skilled in the art. Additionally, network ports will be referred to as EAST and WEST ports, indicating connectivity to equipments located on the left hand side and the right hand side of the equipment respectively according to the corresponding drawings, as will be well understood by those skilled in the art.

The present invention provides building an optical ring network topology consisting of a plurality of layer-2/layer-3/layer-4 switching nodes (referred to as NODES in this document) and dual fiber rings. In particular, this invention utilizes wavelength division multiplexing (WDM) and optical transport and switching mechanisms to ensure very fast automatic protection switching in such a packet ring network without requiring any layer-2/3 signaling or enhancement of the MAC layer.

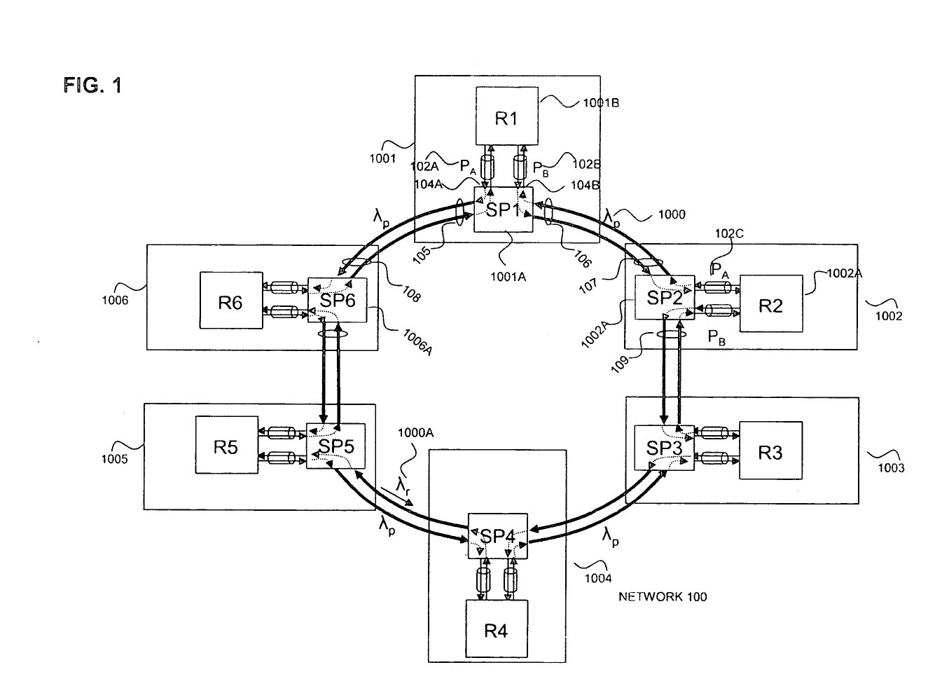

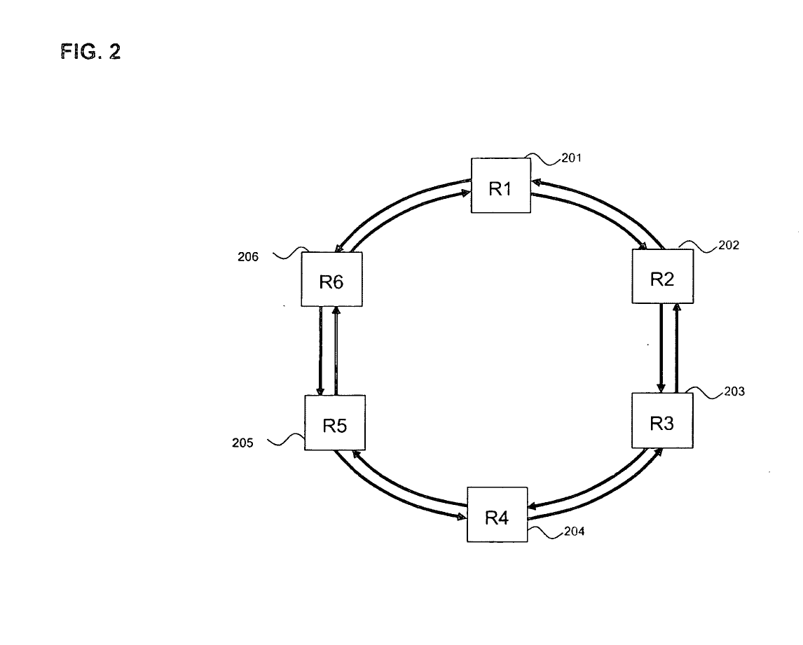

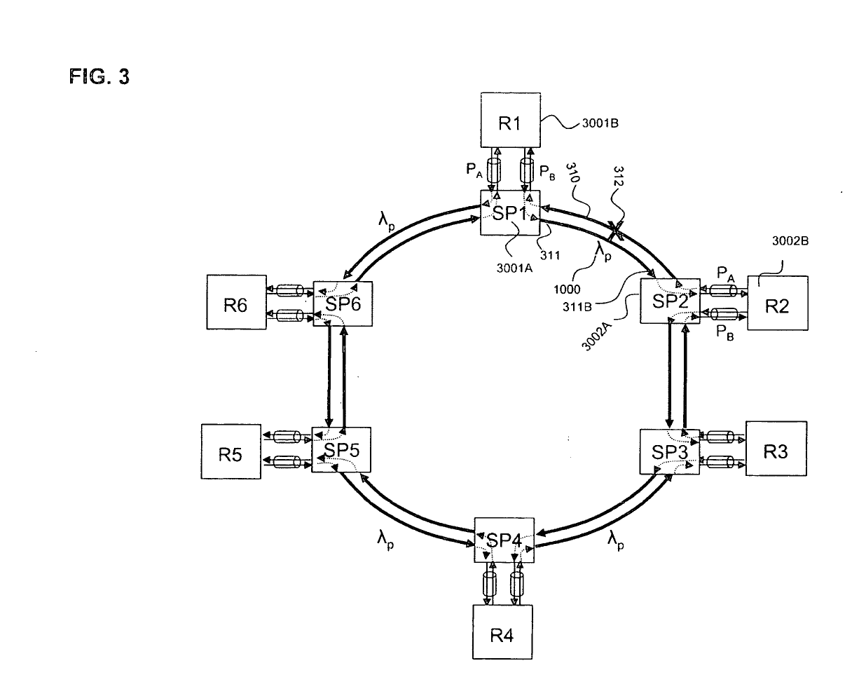

FIG. 1 illustrates a resilient packet-switched photonic network incorporating the invention in accordance with one embodiment. In the illustration, the resilient photonic network 100 consists of one or more resilient switching nodes. Each node consists of a PRISM switch along with a layer-2/3 or higher-layer switching or routing device. As an example, Node-1 1001 consists of a PRISM switch SP1 1001A and a Layer-2/3 switch or router, R1 1001B. Here, SP1 1001A and R1 1001B can be part of a single PRISM equipment in one embodiment and two separate equipments in other embodiments. Two bi-directional ports of R1, P_{A} 102A and P_{B} 102B are connected to a pair of bi-directional ports of SP1 104A and 104B. The bi-directional signal from port-P_{A} and port-P_{B} are converted to optical signals at a specific wavelength λₚ 1000, also referred to as the primary wavelength for the PRISM network. Bi-directional signals from port P_{B} 102B of switch/router R1 are then carried on wavelength λₚ to the EAST network port 106 of SP1 and over to the dual fiber connecting to the WEST network port 107 of the PRISM switch SP2 1002A in Node 2 1002. Similarly, Bi-directional signals from port P_{A} 102A of router R1 are carried on the same wavelength λₚ to the WEST network port 105 of SP1 1001A and over to the dual fiber connecting to the EAST network port 108 of the PRISM switch SP6 1006A in Node 6 1006. SP2 in Node-2 1002 extracts the bi-directional signal from λₚ on the WEST port and forwards the signal to port P_{A} 102C to R2. Thus a direct bi-directional connectivity is established between port P_{B} 102B of R₁ 1001B and port P_{A} 102C of R2 1002B. Similar bi-directional connectivities are established between R2-R3, R3-R4, R4-R5, R5-R6 and R6-R1. Thus a single wavelength, λₚ 1000 is used to establish a daisy-chained connectivity between the layer-2/3/4 switch/routers. The equivalent layer-2 and layer-3 packet ring connectivity established by packet switches/routers R1 201 through R6 206 is illustrated in FIG. 2. Additional layer-2 and layer-3 protocols such as IEEE 802.1d Spanning Tree, IEEE 802.1w rapid spanning tree or Open Shortest Path First (OSPF) routing may also be running on the layer-2/3 switches to prevent broadcast storm and loop formation etc. There is also a reserved wavelength, λᵣ 1000A, assigned to each PRISM ring network 100. During fault-free operation (NORMAL state), every node of the PRISM ring bypasses every wavelength other than the primary wavelength λₚ 1000 including the reserve wavelength λᵣ 1000A. Thus, it will be apparent to those skilled in the art, that one embodiment of this may incorporate plurality of virtual PRISM ring networks 100, each with a pair of dedicated primary and reserve wavelengths, all being transported on a single physical fiber-ring pair utilizing Wavelength Division Multiplexing (WDM). FIG.-3 illustrates a partial failure of a network link, in which only unidirectional communication is lost between PRISM switches SP1 3001A and SP2 3002A. However, this invention is equally applicable to single or plurality of link failures, as well as complete failure of a network link with bidirectional loss of communication. In this example, the communication link 310 is lost between SP2 3002A and SP1 3001A (and in extension between R2 3002B and R1 3001B) due to a network fault condition 312. SP1, upon detection of this link failure, enters the PROTECT mode. It first blocks the primary wavelength, λₚ 1000 on the egress EAST port 311 connecting to SP2. This ensures that SP2 will also detect a link fault on the ingress WEST port 311B connecting to SP1. Through this mechanism, even during a partial failure condition as illustrated in FIG. 3 both the PRISM switches, SP1 and SP2, detect link fault in the segment between them and enter PROTECT mode. If the initial loss of link between SP1 and SP2 is bi-directional instead of unidirectional, then both SP1 and SP2 are already aware of the loss of bi-directional connectivity and will enter PROTECT mode.

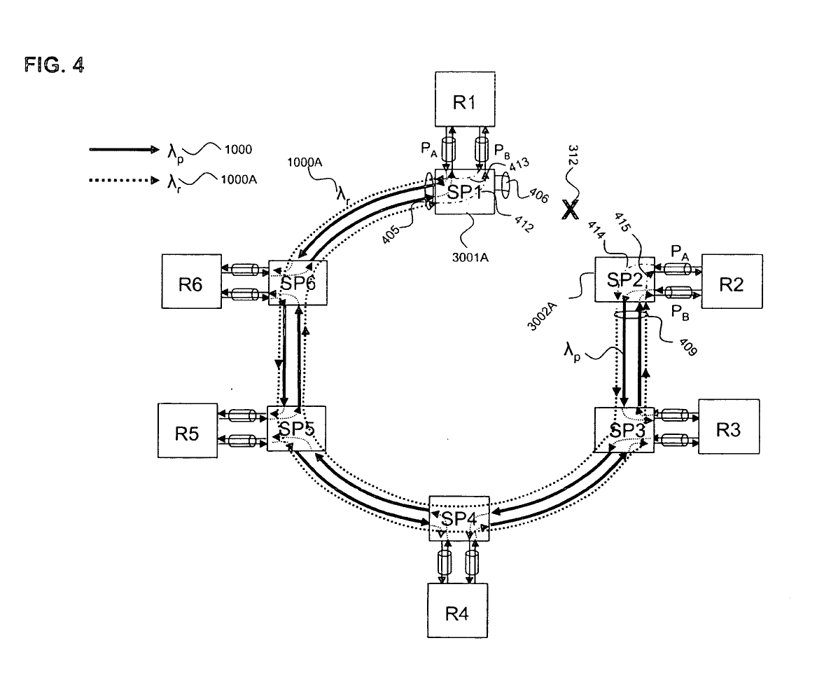

FIG. 4 illustrates a network protection switching operation carried out by the PRISM switches in one embodiment of this invention when SP1 3001A and SP2 3002A switches enter PROTECT mode upon detection of fault. SP1 3001A redirects the egress signal 413 from port P_{B} of R1, previously being transmitted to SP2 on the EAST port 406 on wavelength λₚ 1000, to the WEST egress port 405 on reserve wavelength λᵣ 1000A. SP1 also transitions from local bypass mode to local drop mode for the reserve wavelength λᵣ 1000A. Thus the ingress λᵣ signal 412 from the WEST port of SP1 is locally dropped and forwarded to the ingress of port P_{B} of R1.

Similarly, as illustrated in one embodiment in FIG. 4, upon detection of a link fault between SP1 and SP2, SP2 redirects 414 the egress signal from port P_{A} of R2, previously being transmitted to SP1 on the WEST port on wavelength λₚ, to the EAST egress port 409 on reserve wavelength λᵣ. SP2 also goes from local bypass mode to local drop mode for ingress signal on wavelength λᵣ. The ingress λᵣ signal 415 from the EAST port 409 of SP2 is locally dropped and forwarded to the ingress of port P_{A} of R2.

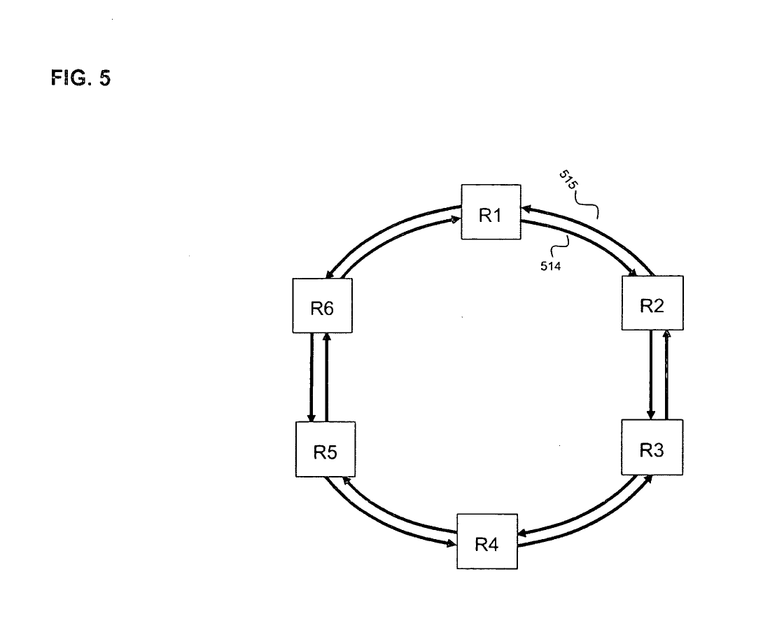

In the embodiment of the invention illustrated in FIG. 4, since all the other nodes between SP1 and SP2 are in NORMAL state, the reserve wavelength λₚ is bypassed everywhere. Consequently, the egress signal 413 from port P_{B} of R1 is bypassed through nodes SP6, SP5, SP4, SP3 and dropped 415 to the ingress of port P_{A} of R2 through SP2. Similarly, the egress signal 414 from port P_{A} of R2 is bypassed through SP3, SP4, SP5, SP6 and dropped 412 to the ingress of port P_{B} of R1. Thus, as illustrated in FIG. 5 the bi-directional layer-2 and layer-3 packet connectivity 514, 515 between R1 and R2 is re-established. As is clear by comparing the pre-fault layer-2, 3 connectivity topology depicted in FIG. 2 and the post protection-switching layer-2, 3 topology depicted in FIG. 5, the layer-2 and layer-3 ring topology remains unchanged. As a result, layer-2 and layer-3 based slower restoration processes such as 802.1w rapid spanning tree or OSPF are not invoked even though they may be running as a background process on the layer-2 and layer-3 switches and routers to prevent broadcast-storm and provide restoration of the global IP network.

For the purpose of thorough understanding, specific numbers and configurations have been set forth in the embodiments illustrated in FIG. 1 through FIG. 5. However, to those skilled in the art, it will be apparent that the present invention may be practiced without these specific details.

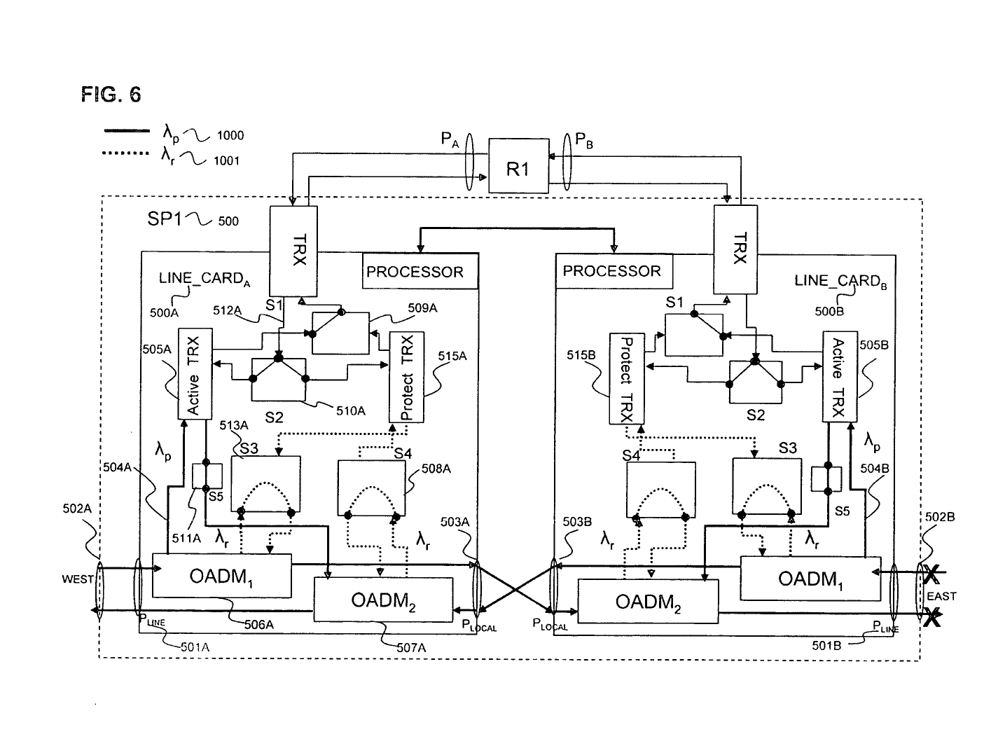

FIG. 6 is an optical and electrical schematic of one preferred embodiment of a PRISM switch. A PRISM switch SP1 500 consists of a single or plurality of identical sub-systems (referred to here as line-cards), such as LINE_CARD_{A}500A and LINE_CARD_{B}500B. It will be well understood by those skilled in the art, that in other embodiments of this invention, the plurality of subsystems or elements of the subsystems may be combined into a single sub-system (line-card) or sub-system element. Each line-card has at least one network facing bi-directional optical fiber port, P_{LINE} and a local bi-directional optical port, P_{LOCAL}. P_{LINE}501A of LINE_CARD_{A} connects to the WEST bi-directional fiber port 502A of SP1 and P_{LINE}501B of LINE_CARD_{B} connects to the EAST bi-directional fiber port 502B of SP1. The egress of local port P_{LOCAL}503A of LINE_CARD_{A} connects to the ingress of local port P_{LOCAL}503B of LINE_CARD_{B} and vice versa. Even though FIG. 6 illustrates the local ports as explicit physical ports, it will be apparent to those skilled in the art that in many embodiments, the local ports can be integral parts of the line-card subsystems or virtual ports. Ingress optical signals from P_{LINE} port of LINE_CARD_{A} enters an optical add-drop multiplexers (OADM), designated OADM₁ 506A. OADM₁ filters out and drops the primary wavelength λₚ 504A to an optical transceiver, Active_TRX 505A. OADM₁ also filters out and drops the reserve wavelength to an optical switch, S3 513A. There is a second optical transceiver Protect_TRX 515A, operating on the reserve wavelength λᵣ that adds the egress signal to the optical switch S3 513A. In NORMAL state, the dropped λᵣ signal from OADM₁ is added back to the OADM by the optical switch, S₃. The λᵣ signal added from Protect_TRX is ignored. All other wavelengths are bypassed by OADM₁ from the ingress to the egress port. Finally, egress of OADM₁ connects to the egress of the local bi-directional fiber-optic port, P_{LOCAL}503A.

In further reference to FIG. 6, ingress of the optical port P_{LOCAL} enters a second OADM, OADM₂ 507A. Egress optical signal in wavelength λₚ from the primary optical transceiver, Active_TRX 505A, is added to OADM₂ through an optical switch, S5 511A, which remains in pass-through mode in the NORMAL state. OADM₂ drops the reserve wavelength, λᵣ, to an optical switch, S4 508A. Additionally, the ingress port of the second optical transceiver, Protect_TRX is tied to S4. In NORMAL state, the dropped λᵣ signal from OADM₂ is added back to the same OADM by the optical switch, S₄. All other wavelengths are bypassed by OADM₂ from the ingress to the egress port. Finally, egress of OADM₂ connects to the egress of the network-facing port, P_{LINE}501A. As illustrated in FIG. 6, the block diagram and the optical and electrical signal paths are identical in the other line-card, LINE_CARD_{B}.

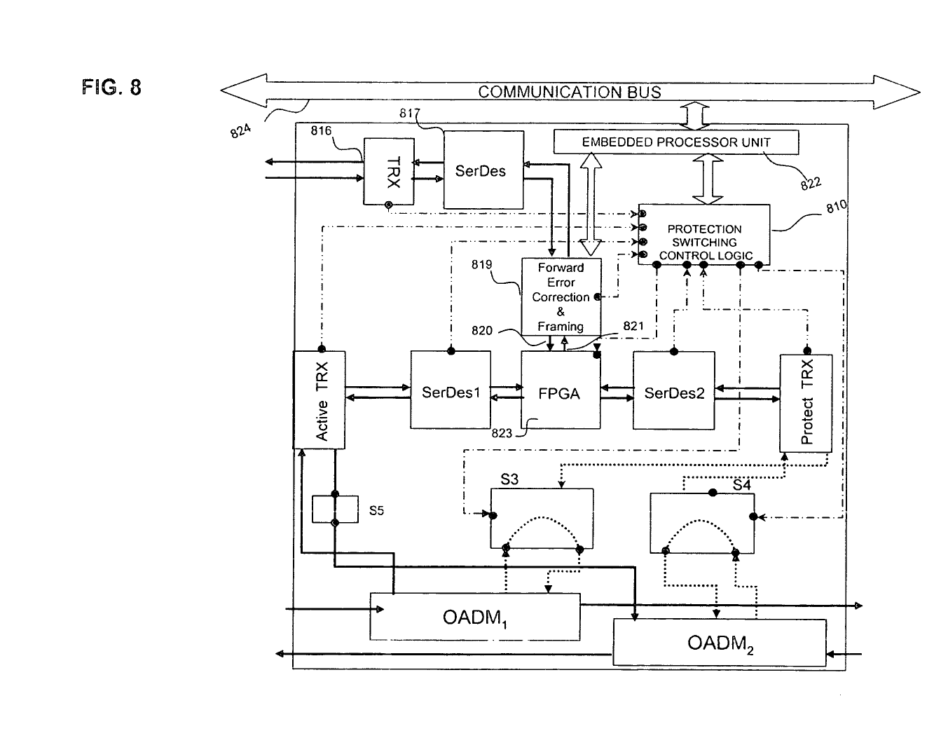

Each of the line-cards also has a client interface facing transceiver, TRX, which can be either optical or electrical. TRX of LINE_CARD_{A} establishes bi-directional connectivity to port P_{A} of the switch/router R1. Similarly, TRX of LINE_CARD_{B} establishes bi-directional connectivity to port P_{B} of R1. Electrical output 512A from TRX in LINE_CARD_{A} enters an electrical sub-system S2 510A, which regenerates, processes and broadcasts the received signal 512A to its two output ports. Output ports of S2 connect to the inputs of Active_TRX and Protect_TRX, which convert these identical electrical signals to optical signals carrying identical information but on different wavelengths λₚ and λᵣ respectively. A second electrical sub-system S2 509A receives electrical signals from Active_TRX and Protect_TRX, regenerates and process them. In NORMAL state, S1 forwards the received electrical signal from Active_TRX to the local transceiver, TRX, connected to R1. An example embodiment of the electrical subsystems S1 and S2 will be described in further details in the following sections with reference to the illustration in FIG. 8. As illustrated in FIG. 6, the block diagram and the optical and electrical signal paths are identical in the other lne-card, LINE_CARD_{B}. LINE_CARD_{A} and LINE_CARD_{B} also have embedded PROCESSOR modules which maintain communication between the line cards, in addition to managing all the subsystems on each of the line cards.

Thus, as illustrated in FIG. 6, in NORMAL operating state, optical circuits in LINE_CARD_{A} and LINE_CARD_{B} optically bypass bi-directional optical signals in the reserve wavelength λᵣ between the EAST and WEST ports of SP1. Bi-directional signals from Ports P_{A} and P_{B} of R1 on the other hand are forwarded in wavelength λₚ to the WEST and EAST ports of SP1 respectively.

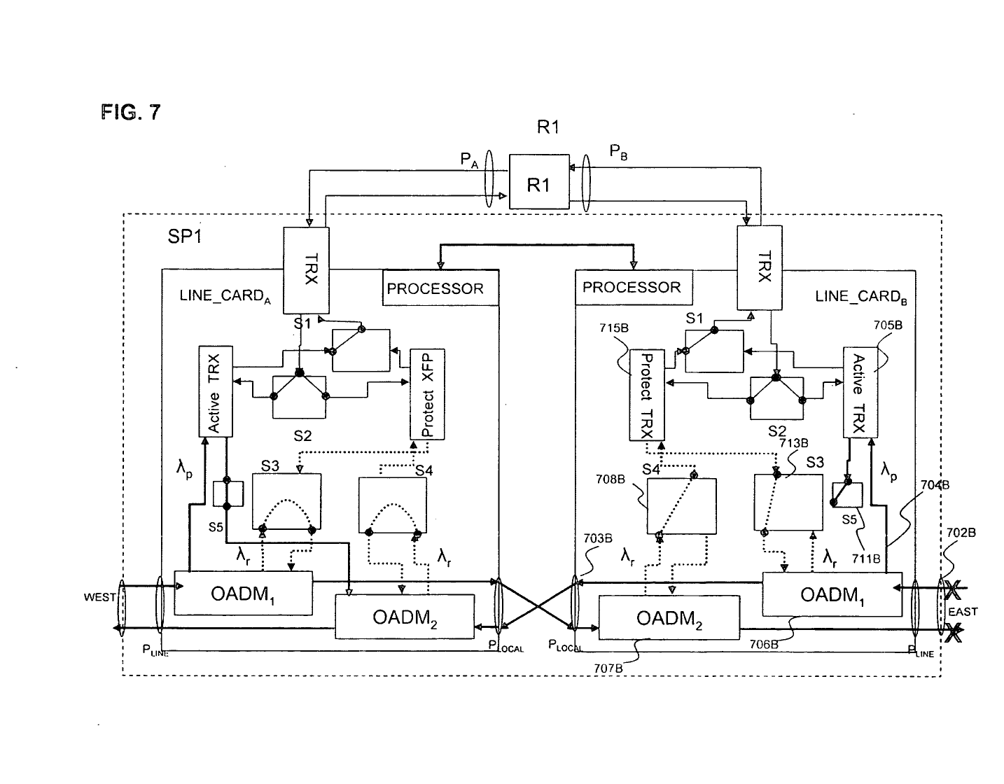

FIG. 7 illustrates the same embodiment of this invention described in FIG. 6 under a network fault condition where either unidirectional or bidirectional communication link to the EAST bi-directional fiber-optic port 702B of SP1 is affected. Ingress signal λₚ 704B to the primary transceiver Active_TRX 705B is affected by this failure and detected by the opto-electronic circuit in LINE_CARD_{B}. Details of the failure detection mechanism will be described in the following sections and illustrated in FIG. 8. Upon detection of an ingress link-failure, LINE_CARD_{B} enters PROTECT state. In this state, switch S5 711B goes into blocking mode, blocking the egress signal in wavelength λₚ from being added to OADM₂ and being transmitted to the EAST port of SP1. Next, switch S4 708B switches state to send the dropped reserved wavelength λᵣ from OADM₂ 707B to the secondary transceiver, Protect_TRX 715B. The electrical subsystem S1 also switches state so that the received optical signal in wavelength λᵣ from OADM₂ is converted into electrical signal by Protect_TRX and upon being processed and regenerated at S1, is forwarded to TRX and ultimately to the ingress of port P_{B} on R1. Finally, the egress signal from P_{B} being processed, regenerated and broadcast by S2 to Protect_TRX is converted to optical signal in wavelength λᵣ and added to OADM₁ when switch S3 713B changes state. This completes switching of the bi-directional signal from P_{B} of R1 into the reserved wavelength λᵣ, sent to the bi-directional local port P_{LOCAL}703B of LINE_CARD_{B}. Since LINE_CARD_{A} has not detected any link failure on the WEST port, LINE_CARD_{A} will remain in NORMAL state. As a result, the bi-directional signal from P_{B} of R1 on reserved wavelength λᵣ received from the P_{LOCAL} port of LINE_CARD_{A} into the P_{LOCAL} port of LINE_CARD_{B} will be bypassed and forwarded to the P_{LINE} port of LINE_CARD_{B} and finally to the WEST network port of SP1. The bi-directional signal from P_{A} of R1 on the other hand is forwarded by LINE_CARD_{A} on wavelength λₚ to the WEST network port of SP1.

FIG. 8 illustrates detailed optical and electrical block-diagram view of the preferred embodiment of the invention described so far. The client-side transceiver TRX 814 sends/receives bi-directional electrical or optical signals to/from an external router/switch port. The bi-directional signal from the external router/switch port is converted into serial electrical signal by TRX. This serial bi-directional signal may optionally be converted to parallel lower-speed data signal through an optional Serializer/De-serializer (SerDes) block 817. The egress signal from TRX or the optional SerDes block can also be optionally framed and encoded with a Forward Error Correction (FEC) encoding through the Forward Error Correction and Framing block (FEC_Framer) 819. The FEC_Framer uses mathematical coding such as Reed-Solomon (RS) code to produce redundant information that gets concatenated with the original signal (referred to as PAYLOAD) to be transmitted. This additional information is used on the ingress interface to help identify transmission errors. The ingress signal 821 into the FEC_Framer block is decoded using the FEC decoder and also corrected for errors. Network status and signaling information are also extracted from the framing overhead by the FEC_Framer block and forwarded to the EMBEDDED PROCESSOR UNIT (EPU) 822. FEC_Framer block also informs the PROTECTION SWITCHING CONTROL LOGIC (PSCL) 810 block of any detected error in the incoming signal.

Bi-directional signals from the FEC_Framer are forwarded to a Field-Programmable Gate Array device or an ASIC (FPGA) 823 where functionalities of the electrical switches S1 and S2 (509A and 510A shown in FIG. 6) are implemented. The egress electrical signal from the FEC_Framer is replicated by the FPGA and broadcast to both Active_TRX and Protect_TRX, optionally through SerDes blocks. Active_TRX and Protect_TRX convert the electrical signals into optical signals at wavelengths λₚ and λᵣ respectively. Conversely, optical signals on wavelength λₚ and λᵣ, received by Active_TRX and Protect_TRX respectively, are converted to electrical signals and sent to the FPGA block through optional SerDes blocks in serial or parallel data format. The FPGA module 823 selects one of these ingress electrical signals based on the control signal from the PSCL module. The selected signal is forwarded to the FEC_Framer block. Both Active_TRX and Protect_TRX modules generate a Loss-of-Signal (LoS) signal based on absence of optical signal (average optical power as well as modulation). LoS signals from the Active_TRX and Protect_TRX modules are used by the PSCL module to determine a link failure condition on the network facing port P_{LINE}. The SerDes blocks also detect loss of signal as well as loss of synchronization (LoL) for the incoming serial data from Active_TRX and Protect_TRX indicating a link failure condition. These signals are forwarded to the PSCL module as well. Finally, the FEC_Framer module can detect framing errors, code violations and high rate of bit error on the incoming signal corresponding to a link failure condition and forward that information to the PSCL module. The PSCL module also communicates with the embedded processor module to get information on the previous state of the line card and other card status information. The decision to switch from NORMAL to PROTECT state is taken by the PSCL module based on all the inputs described here. Presence of a LoS, LoL, framing error or code violation state from the ingress signal chain coming into Active_TRX indicate a link failure condition in the P_{LINE} port and PSCL causes the line card to enter PROTECT state. The new line card state is communicated to the embedded processor module. Also, the embedded processor module communicates with other line cards in the same system chassis through the COMMUNICATION BUS 824 and sends the updated PROTECT status of the line card to the other line cards.

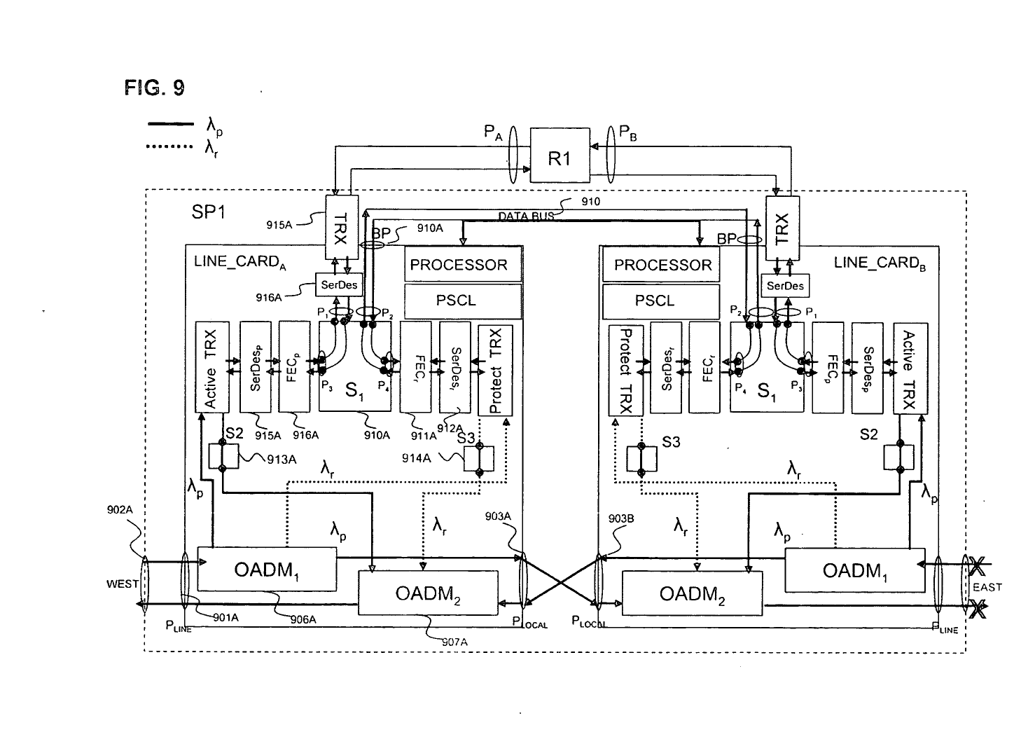

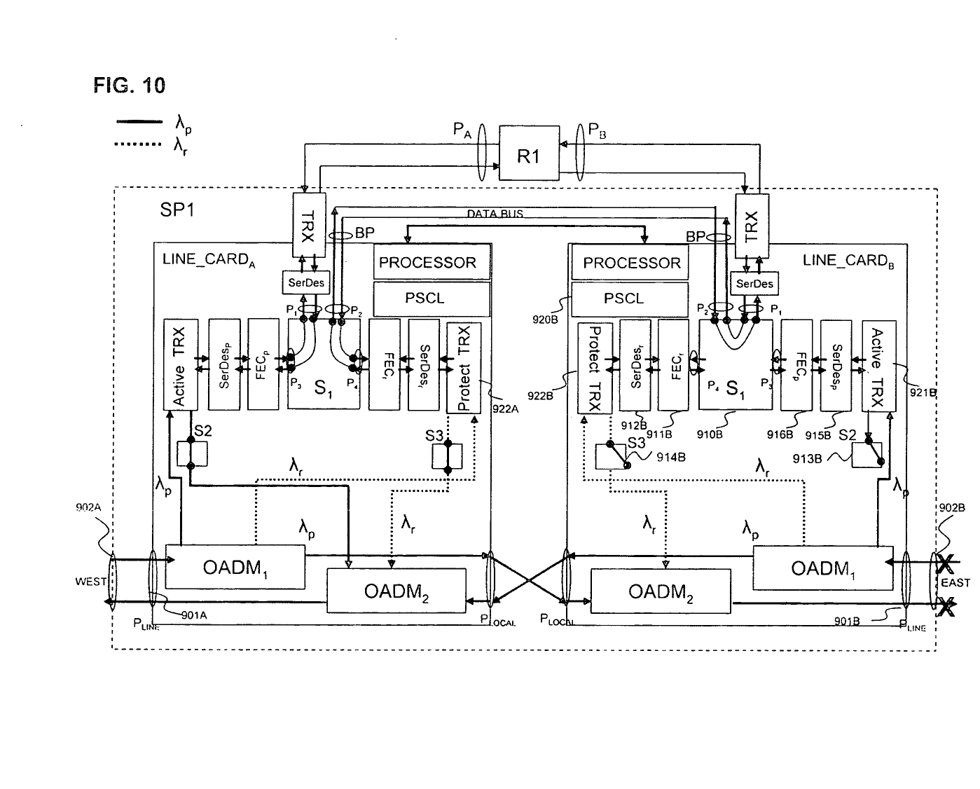

FIG. 9 and FIG. 10 illustrate another preferred embodiment of the invention. FIG. 9 illustrates the optical and electrical schematic of a PRISM equipment consisting of one or a plurality of line-cards. In this embodiment of the invention, the PRISM equipment consists of two identical line cards, LINE_CARD_{A} and LINE_CARD_{B}, each with a network facing bi-directional optical fiber port, P_{LINE} and a local bi-directional optical port, P_{LOCAL}. P_{LINE} of LINE_CARD_{A} connects to the WEST bi-directional fiber port 902A of SP1 and P_{LINE} of LINE_CARD_{B} connects to the EAST bi-directional fiber port 902B of SP1. The egress of local port P_{LOCAL}903A of LINE_CARD_{A} connects to the ingress of local port P_{LOCAL}903B of LINE_CARD_{B} and vice versa.

Each of the line-cards also has a client interface facing transceiver, TRX, which can be either optical or electrical. TRX 915A of LINE_CARD_{A} establishes bi-directional connectivity to port P_{A} of the switch/router R1. Similarly, TRX of LINE_CARD_{B} establishes bi-directional connectivity to port P_{B} of R1. Bi-directional signal from TRX on LINE_CARD_{A} is optionally deserialized/serialized by the SerDes block 916A and fed in parallel or serial format to the first port P₁ of a four-port electrical switch S₁ 910A. S₁ can be realized either by a single or a plurality of FPGAs or application specific integrated circuits (ASIC). The second port, P₂ of S1 connects to a high-speed data bus 910 through a backplane connector BP 910A, connecting LINE_CARD_{A} and LINE_CARD_{B}. The third and fourth ports of S1, P₃ and P₄ connect to two FEC-framer modules, FECₚ 916A and FECᵣ 911A, which then (through optional SerDes blocks) connect to Active_TRX and Protect_TRX.

Ingress optical signal from P_{LINE} 901A of LINE_CARD_{A} enters an optical add/drop multiplexer (OADM), OADM₁ 906A, which then drops the primary wavelength, λₚ to Active_TRX and the reserve wavelength λᵣ to Protect_TRX. Active_TRX and Protect_TRX convert the received optical signals from OADM₁ to serial electrical signals and then optionally to parallel electrical signals through optional SerDes blocks. The serial/parallel electrical signals are fed into FEC modules where the data is decoded using FEC algorithm and corrected for error.

As will be apparent from the illustration in FIG. 9 to those skilled in the art, optical and electrical schematics of LINE_CARD_{B} are identical to those of LINE_CARD_{A}.

In the NORMAL operating state, switch S1 910A forwards bi-directional signals from/to port P₃ of switch S1 to/from port P₁ (i.e. to the TRX through the optional SerDes) and bi-directional signals from/to port P₄ of switch S1 to/from port P₂. Thus the FEC decoded signal from Active_TRX gets forwarded to the egress of TRX. Similarly, incoming signal from TRX is forwarded through S₁ in serial or parallel format to the FEC_{P} 916A module for FEC encoding and framing. The FEC encoded signal, through the optional SerDes block is fed to the Active_TRX where it is converted to optical signal in wavelength λₚ. The egress optical signal in wavelength λₚ from Active_TRX goes through an optical switch S2 913A in transparent state and is added to OADM₂ 907A. Similarly, bi-directional signal in the reserve wavelength λᵣ is converted to electrical signal by the Protect_TRX, optionally deserialized/serialized by SerDesᵣ, FEC decoded/encoded by FECᵣ, 911A and forwarded to the backplane data bus by switch S1. Thus the bi-directional optical signal on the reserved wavelength λᵣ from the EAST port of the PRISM equipment is converted to electrical signal by LINE_CARD_{B}, forwarded to LINE_CARD_{A} through the backplane data bus and converted back to bi-directional optical signal going out at the WEST port of SP1 Thus the reserved wavelength λᵣ is regenerated, reshaped and retimed at SP1 in the NORMAL state without being added or dropped. As before, electrical and optical schematics illustrated in FIG. 9 of LINE_CARD_{B} is identical with the electrical and optical schematics of LINE_CARD_{A}.

FIG. 10 illustrates a failure condition where either unidirectional or bidirectional communication link to the EAST bi-directional fiber-optic port 902B of SP1 is affected. Ingress signal 4 to the primary transceiver Active_TRX 921B in LINE_CARD_{B} is affected by this failure and detected by the PSCL module 920B. The PSCL module is functionally identical to the embodiment illustrated previously in FIG. 8. Upon detection of a link failure condition, PSCL module on LINE_CARD_{B} itches LINE_CARD_{B} to PROTECT mode. In PROTECT mode, switch S1 910B of LINE_CARD_{B} directs the bi-directional traffic from the client facing port TRX to the backplane port BP, which then forwards the traffic through the DATA BUS to LINE_CARD_{A}'s BP port. However, since LINE_CARD_{A} is still in NORMAL state, bi-directional signal received on the BP port will be forwarded through FEC encoding/decoding to Protect_RX 922A. Protect_RX converts this bi-directional signal to wavelength λₚ and forwards to the bi-directional P_{LINE}901A port of LINE_CARD_{A} and ultimately the WEST port 902A of SP1. Thus, the bi-directional signal from P_{B} of R1 is sent to the WEST port of SP1 on reserved wavelength λᵣ upon a link failure on the EAST port. The bi-directional signal from P_{A} of R1 on the other hand is forwarded by LINE_CARD_{A} on wavelength λₚ to the WEST network port of SP1.

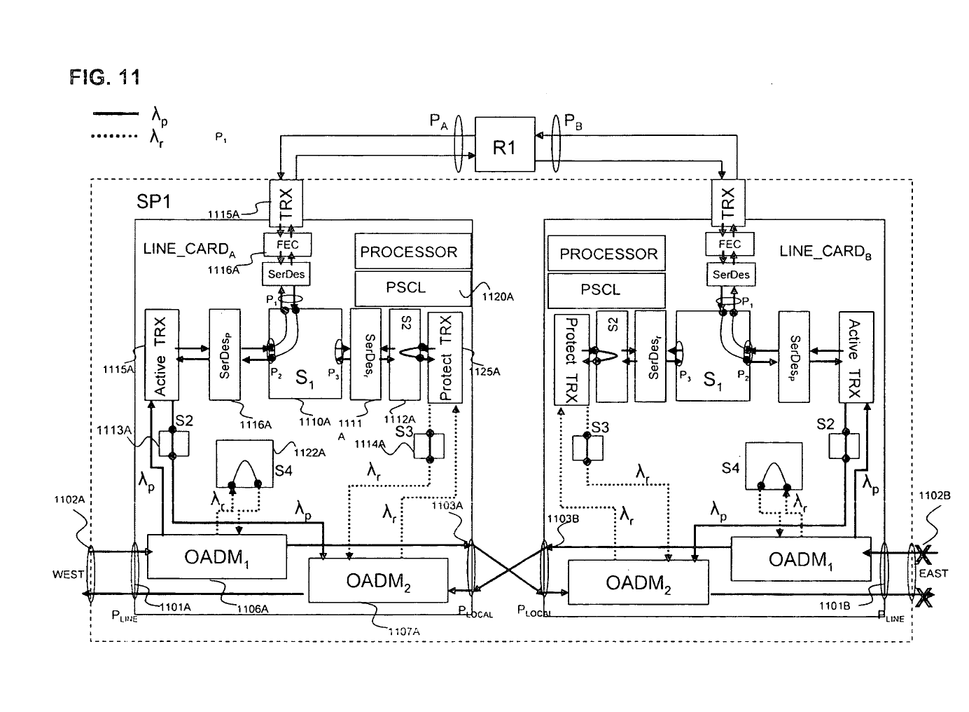

FIG. 11 illustrates yet another embodiment of the invention. Similar to the previous two embodiments, the PRISM equipment described in this embodiment consists of two or more identical line cards, LINE_CARD_{A} and LINE_CARD_{B}, each with a network facing bi-directional optical fiber port, P_{LINE} and a local bi-directional optical port, P_{LOCAL}. P_{LINE}1101A of LINE_CARD_{A} connects to the WEST bi-directional fiber port 1102A of SP1 and P_{LINE} 1101B of LINE_CARD_{B} connects to the EAST bi-directional fiber 1102B port of SP1. The egress of local port P_{LOCAL} 1103A of LINE_CARD_{A} connects to the ingress of local port P_{LOCAL} 1103B of LINE_CARD_{B} and vice versa.

Each of the line-cards also has a client interface facing transceiver, TRX, which can be either optical or electrical. TRX 1115A of LINE_CARD_{A} establishes bi-directional connectivity to port P_{A} of the switch/router R1. Similarly, TRX of LINE_CARD_{B} establishes bi-directional connectivity to port P_{B} of R1. Bi-directional signal from TRX 1115A on LINE_CARD_{A} is FEC encoded/decoded by the FEC framer block 1116A and fed to the first port P₁ of a three-port electrical switch S₁ 1110A through an optional serializer-deserializer block. S₁ can be realized either by one or plurality of FPGAs or through application specific integrated circuits (ASIC). The second and third ports of S1, P₂ and P₃ connect to Active_TRX 1115A and Protect_TRX 1125A through optional SerDes blocks, SerDesₚ 1116A and SerDes, 1112A.

Ingress optical signal from P_{LINE} of LINE_CARD_{A} enter OADM₁ 1106A, which drops the primary wavelength, λₚ to Active_TRX. This optical signal is converted electrically and fed to the ingress port of TRX through S1 and the FEC decoder block. The egress signal from TRX on the other hand is FEC encoded and sent to the ingress electrical port of Active_TRX through optional serialization by SerDesₚ. Active_TRX adds the egress optical signal in wavelength λₚ to OADM₂ 1107A.

As will be apparent from the illustration in FIG. 11 to those skilled in the art, optical and electrical schematics of LINE_CARD_{B} are identical to those of LINE_CARD_{A}.

In the NORMAL operating state, the reserve wavelength λₚ is dropped from OADM₁ 1106A to a 1×2 optical switch S4 1122A, which loops the signal and adds back to OADM₁. The reserve wavelength λᵣ dropped from OADM₂ 1107A on the other hand goes to the optical ingress of Protect_TRX, gets converted to an electrical serial signal and is looped back by an electrical switch S2 1112A. The looped back ingress electrical signal to Protect_TRX is converted to optical signal in wavelength λᵣ and added back to OADM₂. Thus in NORMAL state, the ingress λₚ signal from the EAST port of SP1 is optically bypassed through S4 at OADM₁ of LINE_CARD_{B}, forwarded to LINE_CARD_{A} through the LOCAL_PORTs and electrically regenerated and looped back to OADM2 to be bypassed to the WEST port of SP1. Similarly, ingress λᵣ from the WEST port of SP1 is also optically bypassed, electrically regenerated and then bypassed to the egress of the EAST port of SP1. Bi-directional signals from ports P_{A} and P_{B} of R1 on the other hand are FEC encoded and forwarded to the WEST and EAST ports of SP1 respectively on wavelength λₚ.

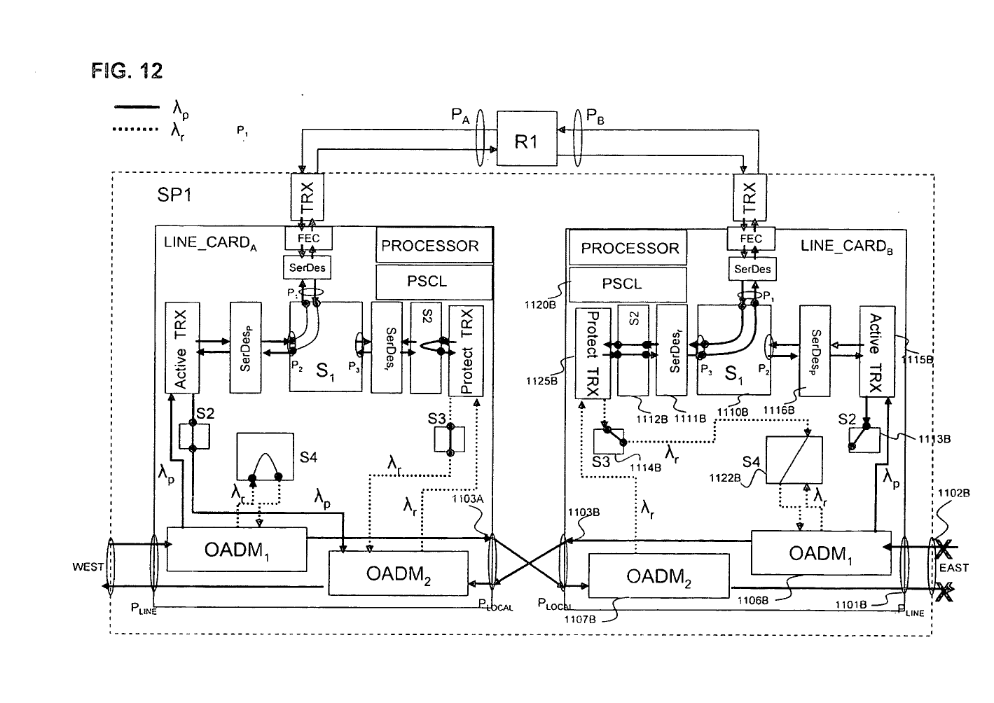

FIG. 12 illustrates a failure condition for the example embodiment illustrated in FIG. 11 where either unidirectional or bidirectional communication link to the EAST bi-directional fiber-optic port 1102B of SP1 is disrupted. Ingress signal λₚ to the primary transceiver Active_TRX 1115B of LINE_CARD_{B} is affected by this failure and detected by the PSCL module 1120B in LINE_CARD_{B}. The PSCL module is functionally identical to the embodiment illustrated previously in FIG. 8. Upon detection of a link failure condition, PSCL module on LINE_CARD_{B} itches LINE_CARD_{B} to PROTECT mode. In PROTECT mode, switch S2 1113B enters blocking state, blocking the egress optical signal λₚ from being added into OADM₂ 1107B. Switch S1 1110B of LINE_CARD_{B} itches state to direct the FEC encoded/decoded bi-directional traffic from the client facing port TRX to port P₃. Also, switch S2 1113B changes state such that bi-directional signal from P₃ port of S1, after being optionally serialized/deserialized, is forwarded to the Protect_TRX 1125B. Optical switches S3 1114B and S4 1122B change states too so that the egress optical signal from Protect_TRX on wavelength λᵣ is added to OADM₁ 1106B and forwarded to the P_{LOCAL} port 1103B of LINE_CARD_{B}. The ingress optical signal on wavelength λᵣ continues to be dropped by OADM₂ into Protect_TRX, which then forwards the converted electrical signal to the client facing transceiver TRX of LINE_CARD_{B}.

Since LINE_CARD_{A} is still in NORMAL state, bi-directional λᵣ signal originating from the P_{B} port of R1 and forwarded to the P_{LOCAL} port 1103A of LINE_CARD_{A} by LINE_CARD_{B} in PROTECT state is electrically regenerated/bypassed to the LINE_PORT of LINE_CARD_{A} and ultimately to the WEST port of SP1. The bi-directional signal from P_{A} of R1 on the other hand is forwarded by LINE_CARD_{A} on wavelength λₚ to the WEST network port of SP1.

It will be apparent to those skilled in the art that various modifications and variations can be made in the method and apparatus for photonic resiliency of a packet switched network of the present invention without departing from the spirit or scope of the invention. Thus, it is intended that the present invention cover the modifications and variations of this invention provided they come within the scope of the appended claims and their equivalents.

What is Claimed is:

1. A resilient photonic network, comprising:
a plurality of resilient switching nodes, each node comprising:
a photonic switch and one of a Layer-2/3 switch and router; and
a plurality of bi-directional ports, each connected between the
photonic switch and the one of a Layer-2/3 switch and router,
wherein at least one optical signal having a specific wavelength is transmitted through a first network port of a first one of the plurality of resilient switching nodes to an adjacent second one of the plurality of resilient switching nodes and the at least one optical signal is transmitted through a second network port of the first one of the plurality of resilient switching nodes to an adjacent third one of the plurality of resilient switching nodes to establish a bi-directional connectivity between the first, second, and third pluralities of resilient switching nodes.

2. The network according to claim 1, wherein the specific wavelength includes a single wavelength.

3. The network according to claim 2, wherein the single wavelength establishes a packet ring connectivity between each of the Layer-2/3 switches and routers.

4. The network according to claim 3, wherein interruption of connectivity between one of the Layer-2/3 switches and routers causes rerouting of the at least one optical signal to others of the Layer-2/3 switches and routers.

5. The network according to claim 1, further comprising a reserve wavelength assigned to each of the photonic switches.

6. The network according to claim 5, wherein during fault-free operation, each of the plurality of nodes bypasses every wavelength other than the specific wavelength and the reserve wavelength.

7. A photonic resiliency and integrated switching mechanism device, comprising:
a plurality of line cards, each line card having at least one bi-directional optical fiber port to transmit and receive a primary wavelength and a reserve wavelength,
wherein an egress of the bi-directional optical fiber port of a first one of the plurality of line cards is connected to an ingress of the bi-directional optical fiber port of a second one of the plurality of line cards, and
wherein an egress of the bi-directional optical fiber port of the second one of the plurality of line cards is connected to an ingress of the bi-directional optical fiber port of the first one of the plurality of line cards.

8. The device according to claim 7, wherein the bi-directional optical fiber port is coupled to at least one optical add-drop multiplexer and a first optical transceiver.

9. The device according to claim 8, wherein the optical add-drop multiplexer filters and removes a primary wavelength of the specific wavelength to the first optical transceiver.

10. The device according to claim 9, wherein the optical add-drop multiplexer filters and removes a reserve wavelength of the specific wavelength to an input of an optical switch.

11. The device according to claim 10, further comprising a second optical transceiver that combines the reserve wavelength to an input of the optical switch.

12. The device according to claim 7, wherein the egress of the bi-directional optical fiber port of the first one of the plurality of line cards is connected to a first optical add-drop multiplexer, and the ingress of the bi-directional optical fiber port of the first one of the plurality of line cards is connected to a second optical add-drop multiplexer.

13. The device according to claim 12, wherein the first optical add-drop multiplexer is connected to a first optical transceiver, and the second optical add-drop multiplexer is connected to an optical switch.

14. The device according to claim 13, wherein the first optical add-drop multiplexer filters and drops the primary wavelength to the first optical transceiver, and the second optical add-drop multiplexer filters and drops the reserve wavelength to the optical switch.

15. The device according to claim 14, during a pass-through mode, the first optical transceiver transmits the primary wavelength to the second optical add-drop multiplexer through an optical switch, and the second optical transceiver transmits the reserve wavelength to a second optical switch.

16. The device according to claim 14, during a protect mode, the second optical transceiver transmits the reserve wavelength to the first optical add-drop multiplexer through the second optical switch, and the second optical add-drop multiplexer filters and removes the reserve wavelength into the second optical transceiver through a third optical switch and the first optical switch prevents transmission of the primary wavelength from the first optical transceiver to the first optical add-drop multiplexer.

17. The device according to claim 16, wherein the first and second optical transceivers are interconnected by first second and third optical switches.

18. The device according to claim 17, wherein the first second and third optical switches are controlled by a protection switching control logic circuit.

19. The device according to claim 16, wherein the first and second optical transceivers are interconnected by a four-port electrical switch.

20. The device according to claim 16, wherein the first and second optical transceivers are interconnected to the four-port electrical switch using a deserializer/serializer block.
